(19) United States
(12) Patent Application Publication
(10) Pub. No.: US 2026/0113742 A1
(43) Pub. Date: Apr. 23, 2026

(54) METHOD AND APPARATUS FOR SATELLITE COMMUNICATION IN NON-TERRESTRIAL NETWORK

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/339,116

(22) Filed: Sep. 24, 2025

Related U.S. Application Data
(63) Continuation of application No. PCT/CN2024/077805, filed on Feb. 20, 2024.

(51) Int. Cl. H04W 72/044; H04J 13/00; H04W 72/231; H04W 72/51

(52) U.S. Cl. CPC H04W 72/0466; H04J 13/004; H04W 72/231; H04W 72/51

(57) ABSTRACT

Provided are a method and an apparatus for satellite communication in a non-terrestrial network. One example method includes: receiving, by a first terminal device, first information from a network device in a non-terrestrial network; determining, by the first terminal device, a first sequence based on the first information; and determining, by the first terminal device, an uplink transmission resource on a first resource block based on the first sequence; wherein the first sequence is a sequence corresponding to the first terminal device in a first sequence set, the first sequence set comprises a plurality of mutually orthogonal sequences, the first terminal device is one of a plurality of terminal devices, and the plurality of terminal devices multiplex the first resource block with a plurality of slots based on the plurality of sequences.

### CROSS-REFERENCE TO RELATED APPLICATIONS

This application is a continuation of International Application No. PCT/CN2024/077805, filed on Feb. 20, 2024, the disclosure of which is hereby incorporated by reference in its entirety.

### TECHNICAL FIELD

The present application relates to the field of communications technologies, and more specifically, to a method and an apparatus for satellite communication in a non-terrestrial network.

### BACKGROUND

In some communications systems (for example, a non-terrestrial network (non-terrestrial network, NTN) system), a communication requirement is high in an uplink. When an uplink channel supports retransmission, load of uplink transmission is further increased. Therefore, in these communications systems, how to enhance a system capacity or how to improve spectrum utilization efficiency becomes a technical problem that needs to be resolved.

### SUMMARY

The present application provides a method and an apparatus for satellite communication in a non-terrestrial network. Aspects involved in embodiments of the present application are described below.

According to a first aspect, a method for satellite communication in a non-terrestrial network is provided, and includes: receiving, by a first terminal device, first information transmitted by a network device, where the first information is used to determine a first sequence; and determining, by the first terminal device, an uplink transmission resource on a first resource block based on the first sequence, where the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

According to a second aspect, a method for satellite communication in a non-terrestrial network is provided, including: transmitting, by a network device, first information to a first terminal device, where the first information is used to determine a first sequence, the first sequence is used by the first terminal device to determine an uplink transmission resource on a first resource block, the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

According to a third aspect, an apparatus for satellite communication in a non-terrestrial network is provided, where the apparatus is a first terminal device, the apparatus includes: a receiving unit, receiving first information transmitted by a network device, where the first information is used to determine a first sequence; and a determining unit, determining an uplink transmission resource on a first resource block based on the first sequence, where the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

According to a fourth aspect, an apparatus for satellite communication in a non-terrestrial network is provided, where the apparatus is a network device, the apparatus includes: a transmitting unit, transmitting first information to a first terminal device, where the first information is used to determine a first sequence, the first sequence is used by the first terminal device to determine an uplink transmission resource on a first resource block, the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

According to a fifth aspect, a communications apparatus is provided, including a memory and a processor. The memory is configured to store a program, and the processor is configured to invoke the program in the memory to perform a method according to the first aspect or the second aspect.

According to a sixth aspect, an apparatus is provided, including a processor, invoking a program from a memory to perform a method according to the first aspect or the second aspect.

According to a seventh aspect, a chip is provided, including a processor, invoking a program from a memory to cause a device on which the chip is installed to perform a method according to the first aspect or the second aspect.

According to an eighth aspect, a computer-readable storage medium is provided. The computer-readable storage medium stores a program, and the program causes a computer to perform a method according to the first aspect or the second aspect.

According to a ninth aspect, a computer program product is provided, where the computer program product includes a program, and the program causes a computer to perform a method according to the first aspect or the second aspect.

According to a tenth aspect, a computer program is provided, and the computer program causes a computer to perform a method according to the first aspect or the second aspect.

A first terminal device in embodiments of the present application may determine a first sequence based on first information, and determine an uplink transmission resource on a first resource block based on the first sequence. The first sequence is a sequence in a first sequence set, and a plurality of sequences in the first sequence set are mutually orthogonal. It may be learned that when a plurality of terminal devices multiplex the first resource block based on the plurality of orthogonal sequences, respectively, a capacity and coverage of an uplink can be effectively enhanced, and spectrum utilization efficiency can be improved.

### BRIEF DESCRIPTION OF THE DRAWINGS

FIG. 1 shows a wireless communications system to which an embodiment of the present application is applied.

FIG. 2 shows an NTN system to which an embodiment of the present application is applied.

FIG. 3 shows another NTN system to which an embodiment of the present application is applied.

FIG. 4 is a schematic flowchart of a method for satellite communication in an NTN according to an embodiment of the present application.

FIG. 5 is a schematic diagram of a possible implementation of the method shown in FIG. 4.

FIG. 6 is a schematic diagram of another possible implementation of the method shown in FIG. 4.

FIG. 7 is a schematic diagram of resource multiplexing implemented by using the method shown in FIG. 6.

FIG. 8 is a schematic structural diagram of an apparatus for satellite communication in an NTN according to an embodiment of the present application.

FIG. 9 is a schematic structural diagram of another apparatus for satellite communication in an NTN according to an embodiment of the present application.

FIG. 10 is a schematic structural diagram of a communications apparatus according to an embodiment of the present application.

### DETAILED DESCRIPTION OF THE EMBODIMENTS

The following describes the technical solutions in embodiments of the present application with reference to the accompanying drawings in embodiments of the present application. Apparently, the described embodiments are some rather than all of embodiments of the present application. For embodiments of the present application, all other embodiments obtained by a person of ordinary skill in the art without creative efforts fall within the protection scope of the present application.

Embodiments of the present application may be applied to various communications systems. For example, embodiments of the present application may be applied to a global system for mobile communications (global system for mobile communications, GSM), a code division multiple access (code division multiple access, CDMA) system, a wideband code division multiple access (wideband code division multiple access, WCDMA) system, a general packet radio service (general packet radio service, GPRS), a long term evolution (long term evolution, LTE) system, an advanced long term evolution (advanced long term evolution, LTE-A) system, a new radio (new radio, NR) system, an evolution system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, an NTN system, a universal mobile telecommunication system (universal mobile telecommunication system, UMTS), a wireless local area network (wireless local area networks, WLAN), wireless fidelity (wireless fidelity, WiFi), and a 5th-generation (5th-generation, 5G) communications system. Embodiments of the present application may be further applied to another communications system, such as a future communications system. The future communications system may be, for example, a 6th-generation (6th-generation, 6G) mobile communications system, or a satellite (satellite) communications system.

Conventional communications systems support a limited quantity of connections and are easy to implement. With the development of communications technologies, a communications system may support not only conventional cellular communication but also one or more other types of communication. For example, the communications system may support one or more types of the following communication: device to device (device to device, D2D) communication, machine to machine (machine to machine, M2M) communication, machine type communication (machine type communication, MTC), enhanced machine type communication (enhanced MTC, eMTC), vehicle to vehicle (vehicle to vehicle, V2V) communication, vehicle to everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to an NTN system. For example, the NTN system may be a 4G-based NTN system, an NR-based NTN system, an internet of things (internet of things, IoT)-based NTN system, or a narrow band-internet of things (narrow band internet of things, NB-IoT)-based NTN system.

The communications system may include one or more terminal devices. The terminal device in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

In some embodiments, the terminal device may be a device providing a user with voice and/or data connectivity. For example, the terminal device may be a handheld device, a vehicle-mounted device, or the like having a wireless connection function. In some specific examples, the terminal device may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may further include one or more network devices. The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names below, or may be interchangeable with the following names, for example: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode MeNB, a secondary eNode SeNB, a multi-standard radio (MSR) node, a home base station, a network controller, an access node, a wireless node, an access point (access point, AP), a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. The base station may be alternatively a mobile switching center, a device that functions as a base station in D2D, V2X, and M2M communication, a network-side device in a 6G network, a device that functions as a base station in a future communications system, or the like. The base station may support networks with a same access technology or different access technologies. A specific technology and a specific device form used by the network device are not limited in embodiments of the present application.

The base station may be fixed or mobile. For example, a helicopter or an unmanned aerial vehicle may be configured to serve as a mobile base station, and one or more cells may move based on a location of the mobile base station. In other examples, a helicopter or an unmanned aerial vehicle may be configured to serve as a device in communication with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile feature, for example, the network device may be a movable device. In some embodiments of the present application, the network device may be a satellite or a balloon station. In some embodiments of the present application, the network device may be alternatively a base station arranged on land, water, or the like.

In embodiments of the present application, the network device may provide a service for a cell, and the terminal device communicates with the network device by using a transmission resource (for example, a frequency resource or a spectrum resource) used by the cell. The cell may be a cell corresponding to the network device (for example, a base station). The cell may belong to a macro base station or belong to a base station corresponding to a small cell (small cell). The small cell herein may include a metro cell (metro cell), a micro cell (micro cell), a pico cell (pico cell), a femto cell (femto cell), and the like. These small cells are characterized by a small coverage range and low transmit power, and are suitable for providing a high-rate data transmission service.

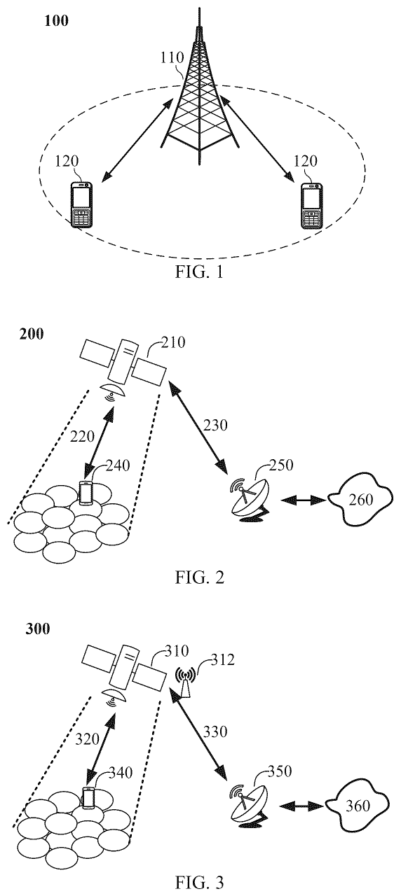

For example, FIG. 1 is a schematic diagram of an architecture of a communications system according to an embodiment of the present application. As shown in FIG. 1, a communications system 100 may include a network device 110, and the network device 110 may be a device that communicates with a terminal device 120 (or referred to as a communications terminal or a terminal). The network device 110 may provide communication coverage for a specific geographic region, and may communicate with a terminal device within the coverage region.

FIG. 1 exemplarily shows one network device and two terminal devices. In some embodiments of the present application, the communications system 100 may include a plurality of network devices, and another quantity of terminal devices may be included within a coverage range of each network device. This is not limited herein.

For example, FIG. 2 is a schematic diagram of an architecture of the foregoing NTN system. An NTN system 200 shown in FIG. 2 uses a satellite 210 as an air platform. As shown in FIG. 2, a satellite radio access network includes the satellite 210, a service link 220, a feeder link 230, a terminal device 240, a gateway (gateway, GW) 250, and a network 260 including a base station and a core network.

The satellite 210 is a spacecraft based on a space platform. The service link 220 is a link between the satellite 210 and the terminal device 240. The feeder link 230 is a link between the gateway 250 and the satellite 210. The Earth-based gateway 250 connects the satellite 210 to the base station or the core network, which specifically depends on a choice of the NTN architecture.

The NTN architecture shown in FIG. 2 is a bent pipe transponder architecture. In this architecture, the base station is located on the Earth behind the gateway 250, and the satellite 210 serves as a relay. The satellite 210 functions as a repeater for forwarding a signal of the feeder link 230 to the service link 220, or forwarding a signal of the service link 220 to the feeder link 230. In other words, the satellite 210 does not have a function of the base station, and communication between the terminal device 240 and the base station in the network 260 needs to be implemented by using the satellite 210.

For example, FIG. 3 is a schematic diagram of another architecture of the NTN system. As shown in FIG. 3, a satellite radio access network 300 includes a satellite 310, a service link 320, a feeder link 330, a terminal device 340, a gateway 350, and a network 360. FIG. 3 differs from FIG. 2 in that a base station 312 is provided on the satellite 310, and the network 360 behind the gateway 350 includes only a core network.

The NTN architecture shown in FIG. 3 is a regenerative transponder architecture. In this architecture, the satellite 310 carries the base station 312, and may be directly connected to an Earth-based core network by using a link. The satellite 310 has a function of the base station, and the terminal device 340 may directly communicate with the satellite 310. Therefore, the satellite 310 may be referred to as a network device.

The communications systems in the architectures shown in FIG. 2 and FIG. 3 may include a plurality of network devices, and another quantity of terminal devices may be included within a coverage range of each network device. This is not limited in embodiments of the present application.

In embodiments of the present application, the wireless communications system shown in FIG. 1 to FIG. 3 may further include another network entity such as a mobility management entity (mobility management entity, MME) or an access and mobility management function (access and mobility management function, AMF). This is not limited in embodiments of the present application.

It should be understood that a device having a communication function in a network/system in embodiments of the present application may be referred to as a communications device. The communications system 100 shown in FIG. 1 is used as an example. The communications device may include a network device 110 and a terminal device 120 that have a communication function. The network device 110 and the terminal device 120 may be specific devices described above. Details are not described herein again. The communications device may further include another device in the communications system 100, such as a network controller or a mobility management entity, which is not limited in embodiments of the present application.

For ease of understanding, some related technical knowledge related to embodiments of the present application is first introduced. The following related technologies, as optional solutions, may be randomly combined with the technical solutions of embodiments of the present application, all of which fall within the protection scope of embodiments of the present application. Embodiments of the present application include at least a part of the following content.

With the development of communications technologies, a communications system (for example, 5G) will have a market potential for integrating a satellite and a terrestrial network infrastructure. For example, 5G standards cause an NTN, including a satellite segment, to become a part of recognized 3rd generation partnership project (3rd generation partnership project, 3GPP) 5G connection infrastructure.

An NTN is a network or a network segment that uses a radio frequency (radio frequency, RF) resource on a satellite or an unmanned aerial system (unmanned aerial system, UAS) platform. A satellite is used as an example. Communications satellites are classified into low earth orbit (low earth orbit, LEO) satellites, medium earth orbit (medium earth orbit, MEO) satellites, geostationary earth orbit (geostationary earth orbit, GEO) satellites, high elliptical orbit (high elliptical orbit, HEO) satellites, and the like depending on different orbital altitudes. An LEO is an Earth-centered orbit with a height of 2000 km or less, or at least 11.25 periods per day, and an eccentricity less than 0.25. Most artificial objects in outer space are located on the LEO. The LEO satellites operate around the Earth at a high speed (mobility), but on a predictable or definite orbit.

Satellites with different orbital altitudes have different orbital periods. For example, a typical height of the LEO is 250 kilometers to 1500 kilometers, and an orbital period is 90 minutes to 120 minutes. A typical height of a MEO is 5000 kilometers to 25000 kilometers, and an orbital period is 3 hours to 15 hours. A height of a GEO is approximately 35786 kilometers, and an orbital period is 24 hours.

It may be learned from FIG. 2 and FIG. 3 in which a satellite is used as an example, a typical scenario of accessing an NTN system by a terminal device involves an NTN transparent payload (payload) or an NTN regenerative payload. The bent pipe transponder architecture shown in FIG. 2 corresponds to the NTN transparent payload, and the regenerative transponder architecture shown in FIG. 3 corresponds to the NTN regenerative payload.

In the NTN system, a terminal device communicates with a network device by using a satellite-mounted or on-board platform. An air platform such as a satellite covers a relatively large area. Therefore, a quantity of terminal devices served in an NTN cell is generally far greater than that in a terrestrial network (terrestrial network, TN) cell. To meet uplink transmission of a terminal device in a cell, a communication requirement of an uplink (uplink, UL) is generally relatively high.

Further, when an uplink channel supports retransmission, uplink transmitting load and overheads are greater. For example, when a physical uplink shared channel (physical uplink shared channel, PUSCH) supports retransmission that is based on a hybrid automatic repeat request (hybrid automatic repeat reQuest, HARQ) mechanism, the network device needs to configure uplink resources for initial transmission and retransmission. Therefore, the uplink transmitting load is also increased.

For ease of understanding, resource configurations of initial transmission and retransmission of a PUSCH are used as an example below for description. In an NTN system, a network device may configure a resource for transmission of a PUSCH in a plurality of manners.

As an example, a transmission resource of the PUSCH is indicated by using downlink control information (downlink control information, DCI). For example, a location of the PUSCH relative to a PDCCH is indicated by a K2+offset field in the DCI. In a TN system, offset=0. K2=0 indicates that the PDSCH and the PDCCH are in a same slot (slot), K2=1 indicates that the PDSCH is in a slot behind the PDCCH, and so on. For another example, PUSCH transmission may be dynamically scheduled by using a DCI format (DCI 0_0/0_1/0_2) in the PDCCH.

As an example, a transmission resource of the PUSCH is determined through a response of a network side. For example, in a four-step random access (random access, RA) process, transmission of a message 3 (MSG3) PUSCH is scheduled by using a random access response (random access response, RAR).

As an example, a transmission resource of the PUSCH is determined by using a configuration parameter of a higher layer such as radio resource control (radio resource control, RRC). For example, in a two-step RA process, the terminal device may determine transmission of a message A (MSGA) PUSCH by using an RRC higher-layer configuration parameter carried in a system information block (system information block, SIB). Further, when a base station side fails to decode the message A PUSCH in the two-step RA process, the two-step RA falls back to the four-step RA process. After the two-step RA falls back to the four-step RA process, a fallback RAR may schedule transmission of the message 3 PUSCH.

As an example, a retransmission resource of the PUSCH may be dynamically scheduled by using a physical downlink control channel (physical downlink control channel, PDCCH), or triggered by configuring a retransmission timer (retransmission timer).

As an example, transmission and retransmission of the PUSCH may be semi-persistently scheduled based on a configured grant (configured grant) in addition to being dynamically scheduled. For a configured grant type 1 (configured grant type1), all parameters transmitted by the PUSCH take effect immediately after being RRC-configured. For a configured grant type 1 (configured grant type2), a part of higher-layer parameters transmitted by the PUSCH are RRC-configured, and remaining parameters are indicated by activating a DCI format.

As an example, DCI may also include resource allocation in frequency domain and a time domain. For example, the DCI may point to a row index (index) of a table by using a time resource indication field. A row corresponding to the row index may indicate a slot offset, a start symbol, and a quantity of symbols. For another example, the DCI may designate a part of a slot for uplink transmitting, and that slot resource allocation in different slots may be different is supported. It should be noted that, for transmission in which a same transport block may be repeatedly transmitted in a maximum of eight slots, a transmission resource is not indicated based on dynamic signaling for a table, but is configured by using a piece of separate RRC signaling.

In summary, the NTN system has a relatively high UL communication requirement. Therefore, how to enhance a capacity and coverage of an uplink and improve spectrum utilization efficiency in the NTN system is a problem worthy of study.

It should be noted that the foregoing problem that a system capacity or spectral efficiency needs to be improved because the uplink transmitting load of the NTN system is relatively heavy is merely an example. Embodiments of the present application may be applied to any type of scenario in which an uplink communication requirement is high. For example, a method in embodiments of the present application is also applicable to a TN network, to improve uplink transmission efficiency of the PUSCH.

Based on this, embodiments of the present application propose use of an orthogonal cover code (orthogonal cover code, OCC) in an NTN system, to improve a system capacity and/or spectral efficiency. In some embodiments, a plurality of terminal devices may use the OCC to multiplex a same physical resource block (physical resource block, PRB). In other words, the plurality of terminal devices may perform transmission on a same PRB by using the OCC. Each terminal device uses an allocated sub-resource block to generate a higher uplink capacity gain, thereby maintaining enhanced uplink coverage.

The OCC is a technology that may implement frequency resource multiplexing in a communications system. The OCC is a group of mutually orthogonal codewords, and a plurality of users may simultaneously perform transmission on a same frequency resource without mutual interference. Specifically, due to orthogonality of orthogonal codes, superposed signals do not interfere with each other in frequency domain, thereby implementing frequency resource multiplexing of the plurality of users. At a receive end, a corresponding demodulation and decoding technology may be used to separate the superposed signals into raw data of each user. For example, in a multi-user scenario, the OCC may be used for resource allocation between a plurality of terminal devices on a same PRB.

Further, to ensure that the superposed signals can be effectively separated and decoded at the receive end, proper synchronization and channel estimation needs to be performed on each PRB to cope with a possible delay and channel fading in transmission.

To resolve some of the foregoing problems, an embodiment of the present application further proposes a method for satellite communication in an NTN. In this method, a first terminal device may determine a first sequence in a plurality of sequences based on first information transmitted by a network device. A plurality of terminal devices may respectively determine sequences corresponding to the plurality of terminal devices in a plurality of mutually orthogonal sequences, to multiplex a first resource block associated with the plurality of sequences.

In some embodiments, a method or an apparatus for satellite communication may include a method or an apparatus for performing wireless communication by using a satellite, or may include a method or an apparatus for performing wireless communication with a satellite.

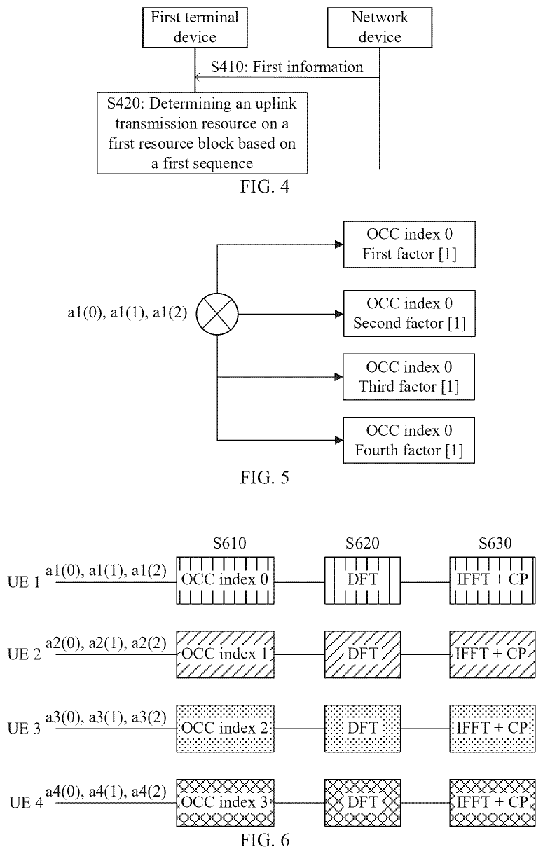

For ease of understanding, a method proposed in an embodiment of the present application is described in detail below with reference to FIG. 4. FIG. 4 is described from the perspective of interaction between a first terminal device and a network device.

Referring to FIG. 4, in Step S410, a first terminal device receives first information transmitted by a network device.

The first terminal device may be any type of terminal device or repeater that performs uplink transmission, which is not limited herein. In some embodiments, the first terminal device may be any terminal device in an NTN system, such as UE. In some embodiments, the first terminal device may be any terminal device in an NB-IoT system.

As an embodiment, the first terminal device is located in a coverage region of a satellite. For example, the first terminal device is an NTN Internet of Things terminal.

As an embodiment, the first terminal device is a communications device that performs uplink transmission to a device on a network side in any communications system.

The network device may be any network device or network side device described above. In some embodiments, the network device includes a satellite in the NTN system, and the first terminal device is a terminal device that performs communication by using the satellite. For example, when a base station is deployed on the satellite, the first terminal device directly communicates with the base station on the satellite. For example, when the satellite serves as a relay, the first terminal device communicates with a terrestrial network device by using the satellite.

As an embodiment, when the network device includes a satellite, the first terminal device is located in a service area of the satellite at a current moment, to receive the first information through the satellite.

The first terminal device is one of a plurality of terminal devices, which means that the first terminal device may be any terminal device in the plurality of terminal devices. A second terminal device except the first terminal device in the plurality of terminal devices may receive second information transmitted by the network device, or may receive the first information together with the first terminal device, which is not limited herein.

In some embodiments, the plurality of terminal devices form a first terminal device group, that is, the first terminal device group includes the plurality of terminal devices. Because the plurality of terminal devices belong to one terminal device set, the network device may transmit indication information to the plurality of terminal devices based on the set.

As an embodiment, when the network device includes a satellite, all the plurality of terminal devices in the first terminal device group are located in a service area of the satellite at a current moment, to receive indication information corresponding to each terminal device through the satellite.

The first information is used to determine a first sequence. The first sequence is a sequence corresponding to the first terminal device in a first sequence set. The first sequence set includes a plurality of mutually orthogonal sequences. A manner of determining the first sequence set is described below with reference to a plurality of formulas.

In some embodiments, the plurality of sequences in the first sequence set are a group of orthogonal codes that may also be referred to as an orthogonal sequence set. As an example, the plurality of sequences in the first sequence set are a group of OCC sequences, and the first sequence is a first OCC sequence. For example, the plurality of sequences in the first sequence set are a group of orthogonal codes selected from an available OCC set, and each sequence may also be referred to as an OCC orthogonal code.

Optionally, the first sequence set may use a Zadoff-Chu (ZC) sequence as an orthogonal code. The ZC sequence is a sequence with good orthogonality. Specifically, the ZC sequence may obtain different orthogonal codes by selecting different root indexes and sequence lengths.

Optionally, the first sequence set may use a Hadamard (Hadamard) matrix as an orthogonal code. The Hadamard matrix is a special orthogonal matrix, all rows of which are mutually orthogonal. In this embodiment of the present application, a row of the Hadamard matrix may be used as an orthogonal cover code. Such a codeword set may ensure good orthogonality in frequency domain. In this way, multi-user frequency resource multiplexing is also implemented.

Optionally, the first sequence set may use comb-like orthogonal codes, so that the plurality of sequences have fixed intervals. For example, the plurality of sequences may have fixed frequency intervals, that is, have equal intervals in frequency domain. By using a design of equal intervals in frequency domain, mutual interference between orthogonal codes used on different sub-carriers may be ensured as small as possible, thereby improving system performance.

Optionally, the plurality of sequences in the first sequence set may implement orthogonality in frequency domain, or may implement orthogonality in time domain, which is not limited herein.

In some embodiments, the plurality of sequences (for example, a group of OCC sequences) in the first sequence set may be used for one or more time domain units. The time domain unit is, for example, a symbol or a slot, which is not limited herein.

Optionally, a group of OCC sequences in the first sequence set may be used for a plurality of symbols or a plurality of slots, to implement resource multiplexing in a scenario of allocating resources across symbols or slots. In this scenario, there are enough sequences between symbols/slots to meet a requirement for simultaneous communication between many terminal devices within a coverage region of an NTN. Illustrative descriptions are provided below with reference to Example 3.

Optionally, a group of OCC sequences in the first sequence set may be distinguished by using a pseudorandom sequence. In other words, a group of OCC sequences across symbols or slots may be distinguished by using the pseudorandom sequence. Illustrative descriptions are provided below with reference to Example 4.

In some embodiments, the plurality of sequences in the first sequence set may be allocated to different terminal devices, thereby supporting multi-user multiplexing of an NR uplink PUSCH on a same PRB. When each terminal device is allocated with an independent sequence (orthogonal code), it may be ensured that signals of the plurality of terminal devices on a same PRB may be distinguished.

In some embodiments, the network device may group data of different terminal devices by using orthogonal codes. For example, the network device may allocate a same first sequence set to adjacent terminal devices, to ensure orthogonality in frequency domain. It may be learned that the network device may not group the terminal devices in advance, but implement resource multiplexing by allocating a same orthogonal code group to the plurality of terminal devices.

As an example, the network device may allocate a unique identifier to each sequence set (OCC code group). A mapping relationship between an identifier and an OCC code group may determine a plurality of different OCC groups.

The plurality of terminal devices including the first terminal device multiplex a first resource block based on the plurality of sequences in the first sequence set. As an example, before performing a discrete Fourier transform (discrete fourier transform, DFT) process, the plurality of terminal devices may process a modulation symbol of uplink data information by using a plurality of corresponding orthogonal codes, to implement an orthogonal code sequence with a specific interval in frequency domain. In an orthogonal frequency division multiplex (orthogonal frequency division multiplex, OFDM) symbol, each sub-carrier may be orthogonal to another sub-carrier by using a corresponding orthogonal code sequence, which is conducive to reduce interference between different sub-carriers and improve system performance.

In some embodiments, the plurality of sequences in the first sequence set are in a one-to-one correspondence with the plurality of terminal devices in the first terminal device group. Therefore, the plurality of sequences may be used by the plurality of terminal devices to perform orthogonal processing on the modulation symbol.

As an example, a one-to-one correspondence may be established between identities (identity, ID) of the plurality of terminal devices and the plurality of sequences.

As an example, indexes of the plurality of sequences in the first sequence set may be separately associated with unique identifiers such as international mobile station equipment identities (international mobile station equipment identity, IMEI) or temporary IMEIs (temporary-IMEI, T-IMEI) of the plurality of terminal devices. In other words, the indexes of the plurality of sequences are in a one-to-one correspondence with the plurality of terminal devices used for resource multiplexing.

In some embodiments, a quantity of the plurality of sequences in the first sequence set is greater than a quantity of the plurality of terminal devices in the first terminal device group. In this scenario, the plurality of sequences in the first sequence set may be used for a plurality of terminal device groups.

After receiving the first information, the first terminal device may determine the first sequence in a plurality of manners. In some embodiments, the first information may directly indicate the first sequence to the first terminal device. In some embodiments, the first information may indicate the first sequence set and an index of the first sequence, and the first terminal device determines the first sequence corresponding to the first terminal device from the first sequence set. In some embodiments, the first sequence set is transmitted in advance to the plurality of terminal devices in the first terminal device group. The first terminal device may determine the index of the first sequence or indexes of a plurality of optional sequences based on the first information, to determine the first sequence.

Before transmitting the first information, the network device may select the first sequence or the first sequence set for the first terminal device based on a plurality of types of information. For example, for a plurality of terminal devices that multiplex a same PRB, the system may select an orthogonal sequence for each terminal device based on a result of channel estimation performed on the terminal device.

In some embodiments, the first sequence may be alternatively determined based on a communication environment and/or a channel status of the first terminal device. In some scenarios, the NTN system may dynamically select the first sequence for the first terminal device based on the communication environment or the channel status, to ensure an optimal uplink peak-to-average ratio. The communication environment may be an interference status in a communication process. The channel status may be determined by using parameters such as Doppler, time change, and phase distortion.

In some embodiments, the system may measure, by using a channel quality metric, performance of using different sequences in a given channel condition. The channel quality metric may include a signal-to-noise ratio (signal noise ratio, SNR), a channel gain, a bit error rate, and the like. An OCC sequence is used as an example, and a selection criterion of the OCC sequence is that an OCC sequence that is best suited to a current channel condition is selected based on the channel quality metric. For example, an OCC sequence with a highest channel quality metric may be selected.

It may be learned that the plurality of sequences in the first sequence set may correspond to one or more channel quality metrics in the channel status of the first terminal device. The first sequence may be determined based on the one or more channel quality metrics. For example, when the plurality of sequences correspond to a plurality of channel quality metrics, a channel quality metric corresponding to the first sequence is a maximum value in the plurality of channel quality metrics.

As an example, based on the following formula, the first sequence X(i) may be selected for the first terminal device based on a signal quality metric Qᵢ:

$$i = arg {max}_{i} C ( {Q}_{i} , )$$

where i is a number of an optimal OCC sequence, and C(·) is a selection criterion function, where the criterion function may make a dynamic trade-off between minimizing interference and maximizing a system capacity, or consider energy efficiency.

Optionally, the selection criterion in the foregoing formula may be defined based on a specific situation. As an example, the selection criterion may involve minimizing power consumption at a specific transmission rate. For example, C(Qᵢ)=Rᵢ/Pᵢ, where Rᵢ is a rate of the terminal device, and Pᵢ is transmit power of the terminal device or power allocated by the NTN network to the terminal device.

In some embodiments, when the system dynamically switches, based on the selection criterion, the sequence corresponding to the terminal device, the switching may be performed at the beginning of each slot or symbol, to adapt to a change of a channel condition.

A network side device may transmit the first information in a plurality of manners. In some embodiments, the first information may be carried in RRC dedicated signaling. In some embodiments, the first information may be carried in DCI transmitted by the network device. In some embodiments, the first information may be configured by using a higher-layer parameter.

Optionally, the network device may determine, from the first sequence set, a first OCC sequence used for uplink data transmission, and then indicate, by using RRC dedicated signaling or DCI of a PDCCH, a first OCC sequence used by the first terminal device.

Optionally, the NTN network may allocate the plurality of terminal devices by using the DCI to multiplex a same PRB. As an example, the first terminal device transmits a PUSCH on a resource set indicated by a PDCCH DCI format. When four terminal devices are multiplexed on one PRB, the four terminal devices may determine, based on the plurality of sequences in the first sequence set, how data transmission is multiplexed on one PRB. For example, the four terminal devices may separately determine, from the first sequence set based on an ID and a sequence index, a sequence used for uplink transmission.

In some embodiments, the network device may determine, based on capability information of the first terminal device, whether to transmit the first information. When the first terminal device supports resource multiplexing, the network device may transmit the first information. When the first terminal device does not support resource multiplexing, the network device does not transmit the first information.

In some embodiments, the network device may receive second information transmitted by the first terminal device, to determine whether the first terminal device has a capability of supporting resource multiplexing. As an example, the network device transmits the first information after receiving the second information and in a case that the second information indicates that the first terminal device has the capability of supporting resource multiplexing.

As an example, the second information may be transmitted by using capability information or UE auxiliary information reported by the first terminal device. For example, an NTN network device may learn, by using capability information or UE auxiliary information reported by one or more terminal devices, whether the one or more terminal devices support resource multiplexing.

Optionally, if the terminal device supports resource multiplexing, the network device may group accessed terminal devices. Based on the grouping or a configuration of the network device, the first terminal device group in which the first terminal device is located may be determined.

It should be understood that, in some scenarios, a terminal device in the terminal device group does not need to know a specific terminal device with which this terminal device forms a group or multiplexes a same resource block.

In some embodiments, the first terminal device group may be determined by the network device by grouping the terminal devices, or may be determined by the network device through pre-configuration. As an example, the network device may group the accessed terminal devices based on one or more pieces of information of the terminal devices, to determine the first terminal device group. As an example, the network device may pre-configure a grouping condition. When the first terminal device meets a condition corresponding to the first terminal device group, the first terminal device belongs to the first terminal device group.

As an embodiment, the network device groups the accessed terminal devices to determine the first terminal device group including the plurality of terminal devices. The accessed terminal devices may be some or all terminal devices that communicate with the network device, which is not limited herein.

In some embodiments, the network device may group the accessed terminal devices based on third information. In other words, the first terminal device group may be determined based on the third information. The third information may include one or more of the following information: a service type of the terminal device, channel quality of the terminal device, location information of the terminal device, or capability information of the terminal device.

Optionally, the network device may group a plurality of terminal devices of a same service type into one group, and implement resource multiplexing by using the first sequence set.

Optionally, the service type may further be related to a resource applied by the terminal device for a service. The network device may group, into one terminal device group, a group of terminal devices to which a same resource needs to be allocated, and allocate orthogonal sequences to these terminal devices, to implement resource multiplexing.

Optionally, the channel quality may be determined based on parameters such as signal strength, a signal-to-noise ratio, and channel fading of a signal received by a communications device.

Optionally, the NTN network may determine the location information of the terminal device based on location measurement or another location calculation manner supported by a global navigation satellite system (global navigation satellite system, GNSS), to allocate orthogonal sequences to terminal devices in a same location area.

As an example, the network device may group the accessed terminal devices by using a service type of the terminal device, a rate, an area, the capability information of the terminal device, and the like. The rate may refer to a transmission rate, and may be determined based on channel quality or the service type.

Optionally, the network device may group a plurality of terminal devices of a same rate into one group, and implement resource multiplexing by using a group of orthogonal codes.

As an example, the network device may group the accessed terminal devices based on locations, channel quality, service requirements, and the like of different terminal devices. The service requirement is related to the service type. The channel quality may be determined through regular measurement.

As an example, location information of the plurality of terminal devices may determine a neighboring relationship between the devices. The network device may group adjacent terminal devices into a same group to minimize interference in frequency domain. For example, the network device may periodically measure channel quality between the terminal devices. The channel quality may be used to determine the location information of the terminal device. Based on the location information of the plurality of terminal devices, a neighboring relationship of the terminal devices may be calculated, to perform grouping.

For example, if a terminal device A and a terminal device B are relatively close to each other, that is, a distance is within a specific range, the terminal device A and the terminal device B may be considered as adjacent.

For example, if the distance between the terminal device A and the terminal device B may be measured by using a European distance, a Manhattan distance, or the like, and is within a specific range, the two terminal devices may be considered as adjacent.

As an example, the network device may group the accessed terminal devices based on a neighboring relationship, channel quality, and a service requirement.

The first terminal device group in which the first terminal device is located may be obtained through grouping in advance, or may dynamically change, which is not limited herein. For example, the plurality of terminal devices may be grouped in advance. For example, in a communication process, the NTN network may temporarily group the plurality of terminal devices into one group. In either case, the NTN may randomly schedule a group of terminal devices to form a terminal device group used for resource multiplexing.

In some embodiments, the NTN network may schedule the plurality of terminal devices through grouping by using an orthogonal sequence set, so that a plurality of terminal devices in one terminal device group multiplex a same resource block when transmitting PUSCH data on an uplink. For example, in NB-IoT, narrowband physical uplink shared channels (narrowband physical uplink shared channel, NPUSCH) transmitted by the plurality of terminal devices may support data multiplexing on a same PRB.

Still referring to FIG. 4, in Step S420, the first terminal device determines an uplink transmission resource on a first resource block based on the first sequence.

The first resource block may be a time resource and/or a frequency resource, which is not limited herein.

In some embodiments, the plurality of terminal devices including the first terminal device multiplex the first resource block, to improve spectrum utilization efficiency. The first resource block may refer to one or more PRBs, or may be one or more resource blocks (resource block, RB), or may be one or more resource elements (resource element, RE), which is not limited herein.

The first resource block being multiplexed may include frequency domain multiplexing of the first resource block and/or time domain multiplexing of the first resource block, which is not limited herein.

As an embodiment, one RB includes a plurality of consecutive symbols in time domain, and includes a plurality of consecutive sub-carriers in frequency domain. For example, one RB includes six or seven consecutive symbols in time domain.

Optionally, the first resource block may include a plurality of time domain units, and the plurality of sequences are mutually orthogonal in the plurality of time domain units. The time domain unit may be a symbol/slot, so that there are enough orthogonal sequences between different symbol/slot, thereby maintaining orthogonality in time domain.

As an embodiment, one RB includes a plurality of REs. For a normal cyclic prefix (cyclic prefix, CP), each RB includes 7×12=84 REs. For an extended cyclic prefix, each RB includes 6×12=72 REs.

Optionally, a plurality of PRBs may correspond to different slots, or may correspond to different symbols in one slot.

In some embodiments, the first terminal device may determine, based on the first sequence, one or more resources corresponding to the first terminal device on the first resource block, to perform uplink transmission on these resources. It may be learned that the plurality of terminal devices may respectively determine mutually orthogonal transmission resources on the first resource block based on the plurality of sequences, to implement resource multiplexing.

As an example, the first terminal device may separately multiply the modulation symbol by a plurality of elements in the first sequence, to make a modulation symbol of data orthogonal to the first sequence. The modulation symbol may also be referred to as a modulation signal. After the plurality of terminal devices are multiplied by the modulation signal based on a plurality of corresponding sequences, different terminal devices are multiplexed on a same PRB without causing interference.

As an example, the plurality of elements in the first sequence may be a plurality of factors. For example, when the first sequence is an OCC sequence [1, 1, 1, 1], the four elements in the first sequence are respectively a first factor to a fourth factor. In other words, values of the first factor to the fourth factor depend on a value of the OCC sequence.

For ease of understanding, the sequence [1, 1, 1, 1] is used as an example below to describe orthogonal processing between a modulation symbol and a sequence with reference to FIG. 5. In FIG. 5, the first terminal device has three modulation symbols: a1(0), a1(1), and a1(2). An index (OCC index) of the first sequence is 0, and the four factors are 1 respectively. In other words, a first factor corresponding to an OCC index 0 is 1, a second factor is 1, a third factor is 1, and a fourth factor is 1. As shown in FIG. 5, the three modulation symbols of the first terminal device are respectively multiplied by the four factors corresponding to the OCC index 0.

Optionally, after the modulation symbol is multiplied by the orthogonal sequence, the symbol may be extended, and then Fourier transform is performed. The Fourier transform may be the DFT described above. A frequency domain symbol may be obtained after DFT processing is performed on a symbol obtained after extension of the orthogonal sequence. For example, after the three modulation symbols in FIG. 5 are respectively multiplied by the four factors, the three modulation symbols may be mapped to the frequency domain through DFT processing.

Optionally, the terminal device may map a generated frequency domain symbol to a resource block (for example, a sub-channel or a sub-carrier). The terminal device performs inverse fast Fourier transform (inverse fast fourier transform, IFFT) and cyclic prefix insertion on a generated mapping symbol to generate a DFT-s-OFDM symbol waveform for transmission in one symbol cycle.

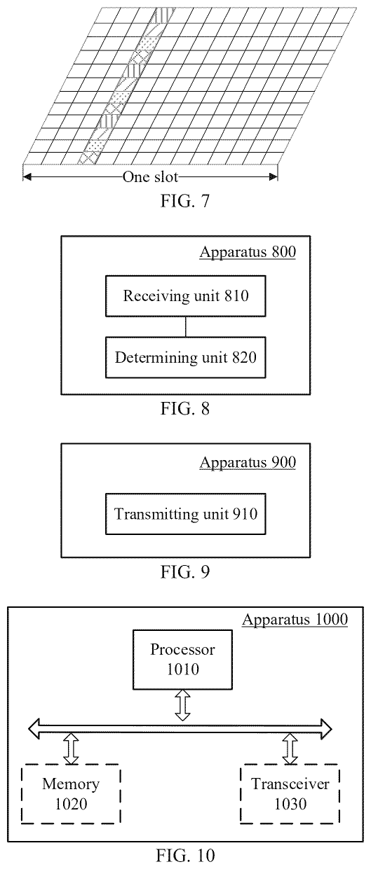

For ease of understanding, four UEs multiplexing the first resource block are used as an example to describe modulation symbol processing and resource multiplexing with reference to FIG. 6 and FIG. 7. The four UEs are respectively UE 1 to UE 4. in frequency domain, 12 sub-carriers are supported, and 12/4=3 modulation symbols corresponding to a PUSCH from the UE 1 to the UE 4 are repeated four times to generate four groups of three modulation symbols. Three modulation symbols of the UE 1 are respectively a1(0), a1(1), and a1(2), three modulation symbols of UE 2 are respectively a2(0), a2(1), and a2(2), and so on.

Referring to FIG. 6, in Step S610, each UE serves as a transmit end, and a modulation symbol of data is first orthogonal to an OCC sequence, to obtain a group of orthogonal modulation symbols that include four subsets of the modulation symbol. Specifically, a sequence with an OCC index 0, a sequence with an OCC index 1, a sequence with an OCC index 2, and a sequence with an OCC index 3 that are respectively used by the four UEs are mutually orthogonal. Three modulation symbols of the UE 1 to the UE 4 are respectively multiplied by OCC sequences corresponding to the UE 1 to the UE 4, to obtain subsets of different scalars. A length of the OCC sequence may be 4. Processing for the UE 1 is shown in FIG. 5. The three modulation symbols of the UE 2 are respectively multiplied by four factors of the sequence with the index 1, three modulation symbols of UE 3 are respectively multiplied by four factors of the sequence with the index 2, and three modulation symbols of the UE 4 are respectively multiplied by four factors of the sequence with the index 3.

In Step S620, M-point discrete Fourier transform is performed on a symbol obtained after the OCC sequences are made orthogonal. An output of the DFT may be mapped to a continuous area of OFDM symbols in frequency domain. In Step S630, a time domain signal is generated through L-point IFFT and addition of a CP.

After a processing process shown in FIG. 6, the four terminal devices may multiplex a same PRB, as shown in FIG. 7. In one slot in FIG. 7, one symbol corresponds to 12 sub-carriers. Sub-carriers covered by different shadows on a fourth symbol mean that the sub-carriers are occupied by different terminal devices, and different shadow patterns respectively correspond to the four UEs in FIG. 6. As shown in FIG. 7, the modulation symbol of the UE 1 is extended (also referred to as spread spectrum) to one of every four sub-carriers of a resource block; the modulation symbol of the UE 2 is extended to one of every four sub-carriers of the resource block, and is offset by one sub-carrier from the UE 1; the modulation symbol of the UE 3 is extended to one of every four sub-carriers of the resource block, and is offset by two sub-carriers from the UE 1; and the modulation symbol of the UE 4 is extended to one of every four sub-carriers of the resource block, and is offset by three sub-carriers from the UE 1.

As an example, the network device receives, on the first resource block, data transmission from uplink PUSCHs of the plurality of terminal devices. Further, the network device may determine, from the first sequence set based on a terminal device ID, a sequence used by each terminal device for uplink transmission, to decode, based on the determined sequence, data included in the uplink transmission.

In some embodiments, the first sequence may be reused. For example, for each different resource block (for example, a PRB), the first sequence corresponding to the first terminal device may be reused to extend the modulation symbol.

It may be learned from FIG. 4 to FIG. 7 that the first terminal device may determine the first sequence by using the first information, to select the uplink transmission resource on the multiplexed first resource block based on the first sequence. When the plurality of terminal devices separately select resources based on corresponding sequences, the first resource block may be multiplexed. However, one resource block is incapable of being simultaneously used by excessive terminal devices. For example, resources of a PRB are limited.

In some embodiments, a maximum quantity of terminal devices that multiplex the first resource block may be M. For example, if M is 4, it may indicate that PUSCH transmitting of four terminal devices is multiplexed on a same PRB.

As an example, M may represent a quantity of terminal devices in the first terminal device group, or may represent a quantity of rows of sequences in the first sequence set. When the plurality of sequences are in a one-to-one correspondence with the plurality of terminal devices, the quantity of terminal devices also determines a quantity of orthogonal sequences.

In some embodiments, a quantity of the plurality of terminal devices that multiplex the first resource block is related to a quantity of sub-carriers or sub-channels corresponding to the first resource block. For example, M needs to be related to a quantity of sub-carriers supported by one PRB.

As an example, a product of the quantity of the plurality of terminal devices and a first parameter is the quantity of sub-carriers corresponding to the first resource block. The first parameter is a positive integer. Optionally, a value of the first parameter may be one of {2, 3, 4, 6}.

As an example, if 12 sub-carriers are supported in one RE, a quantity M of terminal devices that can be supported by a system to multiplex a same PRB is also limited. For example, ∂×M=12, where ∂ is the first parameter. If a value of ∂ is 2, M is 6, that is, the system may support six terminal devices to multiplex a same PRB. If a value of ∂ is 4, M is 3, that is, the system may support three terminal devices to multiplex a same PRB. If a value of ∂ is 6, M is 2, that is, the system may support two terminal devices to multiplex a same PRB.

In some embodiments, when the plurality of sequences are a plurality of row sequences of a first matrix, a quantity of the plurality of terminal devices may also be determined based on an order of the first matrix. For example, the first matrix is a Hadamard matrix. After the Hadamard matrix is generated through recursive construction, each row may be considered as one orthogonal code. An order of the Hadamard matrix determines a quantity of terminal devices that can be supported. Generally, a power of 2, such as 2, 4, 8, or 16, is selected as the order of the matrix.

As an example, the quantity of the plurality of terminal devices is equal to the order of the first matrix.

The quantity of the plurality of terminal devices is described above. When the plurality of terminal devices are in a one-to-one correspondence with the plurality of sequences, the quantity of sequences in the first sequence set is also determined. The plurality of sequences in the first sequence set may be designed in a plurality of manners, which are described below with reference to a plurality of examples.

### Example 1: The First Sequence Set May be a Plurality of Row Sequences of a Matrix

A Hadamard matrix is used as an example. Based on a sequence set of a Hadamard matrix with a length being 2, UE=[x(0), x(1)], UE 1=[1, 1], and UE 2=[1, −1]. A first sequence set based on a Hadamard matrix with a length being 4 may be designed as shown in Table 1.

TABLE 1

| Index | [X(0), X(1), X(2), X(3)] |
|---|---|
| 0 | [+1, +1, +1, +1] |
| 1 | [+1, −1, +1, −1] |
| 2 | [+1, +1, −1, −1] |
| 3 | [+1, −1, −1, +1] |

In Table 1, the indexes 0 to 3 respectively correspond to the UE 1 to the UE 4, that is, UE=[x(0), x(1), x(2), x(3)]. As shown in Table 1, sequences corresponding to the four UEs are respectively: UE 1=[1, 1, 1, 1], UE 2=[1, −1, 1, −1], UE 3=[1, 1, 1, −1], and UE 4=[1, −1, −1, 1], to implement orthogonality of PUSCHs multiplexed in frequency domain.

The matrix may be alternatively an OCC matrix. Based on the OCC matrix, each row may be used as one orthogonal code. A plurality of orthogonal codes may multiplex uplink PUSCHs with different duration on a same resource. In addition, it may be indicated in a DCI format of a downlink PDCCH that an orthogonal code of each UE is allocated to a maximum of M UEs to use a same time-frequency resource, and M is a quantity of rows of the OCC matrix.

### Example 2

The first sequence set is a plurality of OCC sequences. If k terminal devices are scheduled to transmit PUSCHs on one PRB, where k is a natural number greater than 1, the first sequence set may include:
a 1^{st} sequence [1, 1, 1, 1, . . . , 1, 1]; and
an s^{th} sequence

$$\begin{matrix}[ 1 , exp ( j * 2 * \frac{π}{k} * ( s - 1 ) ) , 1 , exp ( j * 2 * \frac{π}{k} * ( s - 1 ) * 2 ) , … , 1 , \\ exp ( j * 2 * \frac{π}{k} * ( s - 1 ) * ( k - 1 ) ) ] ,\end{matrix}$$

where j represents an imaginary unit, and 1<s≤k.

UE 1 to UE k may have the 1^{st} sequence to a k^{th} sequence, respectively. For example, when s is 2, UE 2 has a 2^{nd} sequence, that is,

$$\begin{matrix}[ 1 , exp ( j * 2 * \frac{π}{k} ) , 1 , exp ( j * 2 * \frac{π}{k} * 2 ) , … , 1 , \\ exp ( j * 2 * \frac{π}{k} * ( k - 1 ) ) ] .\end{matrix}$$

It may be learned from the foregoing formula that the plurality of sequences are mutually orthogonal. A plurality of UEs may respectively select corresponding orthogonal codes, so that uplink transmission of different UEs is orthogonal in frequency domain after DFT processing.

### Example 3

The plurality of sequences in the first sequence set may be determined based on a plurality of different root sequences. In other words, different orthogonal codes are generated based on different root sequences. Due to wide coverage of an NTN system, the network device may cover many UEs that simultaneously perform communication. If only four UEs are supported to be multiplexed on one PRB based on a system capability, a large quantity of sets of orthogonal sequences are required. In this scenario, each PRB may multiplex orthogonal codes of the four UEs, and a plurality of sequences used by each PRB are different. In other words, it is necessary to ensure that different sequence sets are used on adjacent symbols/slots. If a time resource occupies only one symbol, adjacent symbols are used. If a time resource occupies one or more slots, adjacent slots are used. This means that there should be sufficient sets of orthogonal sequences between symbols/slots, so that a different set of sequences may be selected for each symbol/slot, and orthogonality in the case of resource allocation across symbols or slots may also be ensured. Therefore, to ensure sufficient sequence sets to meet orthogonality between different symbols/slots, new orthogonal sequences may be generated between different symbols/slots through a cyclic shift of the root sequence.

As an example, logical indexes corresponding to different symbols/slots may be indicated on a PDCCH or in an information field carried on the PDCCH.

As an example, the plurality of different root sequences may be generated based on a cyclic shift of a first root sequence. For example, the first root sequence may be a root sequence of a ZC sequence. Orthogonality in frequency domain and the time domain may be ensured through the cyclic shift of the first root sequence.

As an example, a sequence X_{m,n} obtained after the first root sequence is cyclically shifted may be represented as follows:

$${X}_{m , n} = {X}_{m} [ ( n + {C}_{n} ) mod N ] ,$$

where N represents a length of the sequence (a length of a sequence in the first sequence set), n represents a sequence number of the cyclic shift performed on the first root sequence, n=0, 1, . . . , └N/S_{CS}┘−1, S_{CS} represents a step of the cyclic shift, Cₙ represents a quantity of steps of a cyclic shift corresponding to n, Cₙ=n*S_{cs}, Xₘ represents the first root sequence, m represents an index of the first root sequence, and 0≤m<N.

Further, an element Xₘ(i) in the first root sequence Xₘ may be represented as follows:

$${X}_{m} ( i ) = {e}^{- j \frac{π mi ( i + 1 )}{N}} ,$$

where N represents a length of the first root sequence, and i=0, 1, . . . , N−1.

As another example, a ZC sequence with a length being N may further be represented by the following formula:

$$X ( i ) = {e}^{- j \frac{π mi ( i + 1 )}{N}} ,$$

where m represents a root sequence of the ZC sequence, and i=0, 1, . . . , N−1. A given ZC sequence may be cyclically shifted to the right or cyclically shifted to the left, to obtain a new ZC sequence. Cyclically shifted ZC sequences still remain orthogonality because they still have a same root index. When a ZC sequence X and the quantity Cₙ of steps of the cyclic shift are given, a mathematical representation of a new sequence Y(n) obtained after a cyclic shift to the right is as follows:

$$Y ( n ) = X [ ( n - {C}_{n} ) mod N ] .$$

Alternatively, a mathematical representation of a new sequence Y(n) obtained after a cyclic shift to the left is: Y(n)=X[(n+Cₙ)mod N].

In an actual system, a group of ZC sequences are usually calculated in advance and cyclically shifted at run time as required, to dynamically generate sequences that meet an orthogonality requirement. In addition, a policy for selecting the root sequence may be alternatively determined based on a system requirement, and static root sequence allocation may be used, or adjustment may be performed based on a dynamic channel status, to improve system performance.

### Example 4

The plurality of sequences in the first sequence set may be determined based on a same root sequence. In other words, a plurality of different sequences or sequence sets are generated without changing the root sequence, to meet a requirement of simultaneous communication of the plurality of terminal devices. To generate enough sequences to maintain orthogonality in time domain and the frequency domain, randomness needs to be introduced in time domain when all symbols/slots use a same sequence set.

As an example, a pseudorandom sequence may be used to introduce randomness in adjacent slots or PRBs, thereby improving orthogonality. The pseudorandom sequence may be generated by using a pseudorandom bit generator (pseudorandom bit generator, PRBG). For example, the pseudorandom sequence bit generator may use a linear feedback shift register (linear feedback shift register, LFSR) or a similar structure.

Optionally, the first sequence set may generate different pseudorandom sequences based on different seeds. Different pseudorandom seeds are selected for each adjacent slot or PRB. The pseudorandom seed may be an integer value, and each integer value corresponds to a different pseudorandom sequence. If the pseudorandom sequence bit generator is used to generate a pseudorandom sequence with a length being N, an element Eₛ(x) in an s^{th} sequence in the plurality of sequences may be represented as follows:

$${E}_{s} ( x ) = PRBG ( {P}_{s} , x ) ,$$

where x represents an element index, Pₛ represents a pseudorandom seed of the s^{th} sequence, and PRBG(·) represents a pseudorandom sequence bit generator function.

The foregoing plurality of sequences may be a plurality of sequences in a sequence set of adjacent slots or PRBs. Because different pseudorandom seeds are selected, sequence sets generated in adjacent slots or PRBs have specific randomness. This is conducive to reduce a probability of interference and improve orthogonality. In an actual system, quality of the pseudorandom sequence bit generator needs to be ensured to be good enough to ensure that a generated sequence has a good pseudorandom property. In addition, a policy for selecting the pseudorandom seed may be alternatively determined based on a system requirement, and static seed allocation may be used, or adjustment may be performed based on a dynamic channel status, to improve system performance.

Method embodiments of the present application are described in detail above with reference to FIG. 1 to FIG. 7. Apparatus embodiments of the present application are described in detail below with reference to FIG. 8 to FIG. 10. It should be understood that the description of the apparatus embodiments corresponds to the description of the method embodiments, and therefore, for parts that are not described in detail, reference may be made to the foregoing method embodiments.

FIG. 8 is a schematic block diagram of an apparatus for satellite communication in an NTN according to an embodiment of the present application. The apparatus 800 may be any first terminal device described above. The apparatus 800 shown in FIG. 8 includes a receiving unit 810 and a determining unit 820.

The receiving unit 810 may be configured to receive first information transmitted by a network device, where the first information is used to determine a first sequence.

The determining unit 820 may be configured to determine an uplink transmission resource on a first resource block based on the first sequence, where the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

Optionally, the plurality of sequences are in a one-to-one correspondence with the plurality of terminal devices.

Optionally, the first information is carried in RRC dedicated signaling and/or DCI.

Optionally, the apparatus 800 further includes a transmitting unit that may be configured to transmit second information to the network device before the first information is received, where the second information is used to indicate whether the first terminal device has a capability of supporting resource multiplexing.

Optionally, the plurality of terminal devices form a first terminal device group, the first terminal device group is determined based on third information, and the third information includes one or more of the following information: a service type of the terminal device, channel quality of the terminal device, location information of the terminal device, or capability information of the terminal device.

Optionally, a quantity of the plurality of terminal devices is related to a quantity of sub-carriers or sub-channels corresponding to the first resource block.

Optionally, a product of the quantity of the plurality of terminal devices and a first parameter is the quantity of sub-carriers corresponding to the first resource block, and the first parameter is a positive integer.

Optionally, the plurality of sequences are a plurality of row sequences of a first matrix, and a quantity of the plurality of terminal devices is determined based on an order of the first matrix.

Optionally, the first sequence is further determined based on a communication environment and/or a channel status of the first terminal device.

Optionally, the plurality of sequences correspond to one or more channel quality metrics in the channel status of the first terminal device, and the first sequence is determined based on the one or more channel quality metrics.

Optionally, when the plurality of sequences correspond to a plurality of channel quality metrics, a channel quality metric corresponding to the first sequence is a maximum value in the plurality of channel quality metrics.

Optionally, a quantity of the plurality of terminal devices is k, k is a natural number greater than 1, and the first sequence set includes:
a 1^{st} sequence [1, 1, 1, 1, . . . , 1, 1]; and
a s^{th} sequence

$$\begin{matrix}[ 1 , exp ( j * 2 * \frac{π}{k} * ( s - 1 ) ) , 1 , exp ( j * 2 * \frac{π}{k} * ( s - 1 ) * 2 ) , … , 1 , \\ exp ( j * 2 * \frac{π}{k} * ( s - 1 ) * ( k - 1 ) ) ] ,\end{matrix}$$

where j represents an imaginary unit, and 1<s≤k.

Optionally, the plurality of sequences are determined based on a plurality of different root sequences, and the plurality of different root sequences are generated based on a cyclic shift of a first root sequence.

Optionally, a sequence X_{m,n} obtained after the first root sequence is cyclically shifted is:

$${X}_{m , n} = {X}_{m} [ ( n + {C}_{n} ) mod N ] ,$$

where N represents a length of the sequence, n represents a sequence number of the cyclic shift performed on the first root sequence, n=0, 1, . . . , └N/S_{CS}┘−1, S_{CS} represents a step of the cyclic shift, Cₙ represents a quantity of steps of a cyclic shift corresponding to n, Cₙ=n*S_{cs}, Xₘ represents the first root sequence, m represents an index of first root sequence, and 0≤m<N.

Optionally, an element Xₘ(i) in the first root sequence Xₘ is:

$${X}_{m} ( i ) = {e}^{- j \frac{π mi ( i + 1 )}{N}} ,$$

where N represents a length of the first root sequence, and i=0, 1, . . . , N−1.

Optionally, the plurality of sequences are determined based on a same root sequence.

Optionally, the apparatus 800 further includes a processing unit that may be configured to separately multiply a modulation symbol by a plurality of elements in the first sequence.

Optionally, the plurality of sequences are a group of OCC sequences, and the first sequence is a first OCC sequence.

Optionally, the group of OCC sequences are used for a plurality of symbols or a plurality of slots.

Optionally, the group of OCC sequences are distinguished by using a pseudorandom sequence.

FIG. 9 is a schematic block diagram of an apparatus for satellite communication in an NTN according to an embodiment of the present application. The apparatus 900 may be any network device described above. The apparatus 900 shown in FIG. 9 includes a transmitting unit 910.

The transmitting unit 910 may be configured to transmit first information to a first terminal device, where the first information is used to determine a first sequence, the first sequence is used by the first terminal device to determine an uplink transmission resource on a first resource block, the first sequence is a sequence corresponding to the first terminal device in a first sequence set, the first sequence set includes a plurality of mutually orthogonal sequences, the first terminal device is one of a plurality of terminal devices, and the plurality of terminal devices multiplex the first resource block based on the plurality of sequences.

Optionally, the plurality of sequences are in a one-to-one correspondence with the plurality of terminal devices.

Optionally, the first information is carried in RRC dedicated signaling and/or DCI.

Optionally, the apparatus 900 further includes a receiving unit that may be configured to receive, before the first information is transmitted, second information transmitted by the first terminal device, where the second information is used to indicate whether the first terminal device has a capability of supporting resource multiplexing.

Optionally, the apparatus 900 further includes a processing unit that may be configured to group accessed terminal devices to determine a first terminal device group including the plurality of terminal devices, where the first terminal device group is determined based on third information, and the third information includes one or more of the following information: a service type of the terminal device, channel quality of the terminal device, location information of the terminal device, or capability information of the terminal device.

Optionally, the apparatus 900 further includes a determining unit, determining the first resource block corresponding to the first terminal device group by using a scheduling algorithm.

Optionally, a quantity of the plurality of terminal devices is related to a quantity of sub-carriers or sub-channels corresponding to the first resource block.

Optionally, a product of the quantity of the plurality of terminal devices and a first parameter is the quantity of sub-carriers corresponding to the first resource block, and the first parameter is a positive integer.

Optionally, the plurality of sequences are a plurality of row sequences of a first matrix, and a quantity of the plurality of terminal devices is determined based on an order of the first matrix.

Optionally, the first sequence is further determined based on a communication environment and/or a channel status of the first terminal device.

Optionally, the plurality of sequences correspond to one or more channel quality metrics in the channel status of the first terminal device, and the first sequence is determined based on the one or more channel quality metrics.

Optionally, when the plurality of sequences correspond to a plurality of channel quality metrics, a channel quality metric corresponding to the first sequence is a maximum value in the plurality of channel quality metrics.

Optionally, a quantity of the plurality of terminal devices is k, k is a natural number greater than 1, and the first sequence set includes:
a 1^{st} sequence [1, 1, 1, 1, . . . , 1, 1]; and
an s^{th} sequence

$$\begin{matrix}[ 1 , exp ( j * 2 * \frac{π}{k} * ( s - 1 ) ) , 1 , exp ( j * 2 * \frac{π}{k} * ( s - 1 ) * 2 ) , … , 1 , \\ exp ( j * 2 * \frac{π}{k} * ( s - 1 ) * ( k - 1 ) ) ] ,\end{matrix}$$

where j represents an imaginary unit, and 1<s≤k.

Optionally, the plurality of sequences are determined based on a plurality of different root sequences, and the plurality of different root sequences are generated based on a cyclic shift of a first root sequence.

Optionally, a sequence X_{m,n} obtained after the first root sequence is cyclically shifted is:

$${X}_{m , n} = {X}_{m} [ ( n + {C}_{n} ) mod N ] ,$$

where N represents a length of the sequence, n represents a sequence number of the cyclic shift performed on the first root sequence, n=0, 1, . . . , └N/S_{CS}┘−1, S_{CS} represents a step of the cyclic shift, Cₙ represents a quantity of steps of a cyclic shift corresponding to n, Cₙ=n*S_{cs}, Xₘ represents the first root sequence, m represents an index of first root sequence, and 0≤m<N.

Optionally, an element Xₘ(i) in the first root sequence Xₘ is:

$${X}_{m} ( i ) = {e}^{- j \frac{π mi ( i + 1 )}{N}} ,$$

where N represents a length of the first root sequence, and i=0, 1, . . . , N−1.

Optionally, the plurality of sequences are determined based on a same root sequence.

Optionally, the plurality of sequences are a group of OCC sequences, and the first sequence is a first OCC sequence.

Optionally, the group of OCC sequences are used for a plurality of symbols or a plurality of slots.

Optionally, the group of OCC sequences are distinguished by using a pseudorandom sequence.

FIG. 10 is a schematic structural diagram of a communications apparatus according to an embodiment of the present application. Dashed lines in FIG. 10 indicate that a unit or module is optional. The apparatus 1000 may be configured to implement a method described in the foregoing method embodiments. The apparatus 1000 may be a chip, a terminal device, or a network device.

The apparatus 1000 may include one or more processors 1010. The processor 1010 may support the apparatus 1000 to implement a method described in the foregoing method embodiments. The processor 1010 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program, and the program may be executed by the processor 1010, so that the processor 1010 perform a method described in the foregoing method embodiments. The memory 1020 may be separate from the processor 1010 or may be integrated into the processor 1010.

The apparatus 1000 may further include a transceiver 1030. The processor 1010 may communicate with another device or chip through the transceiver 1030. For example, the processor 1010 may transmit data to and receive data from another device or chip through the transceiver 1030.

An embodiment of the present application further provides a computer-readable storage medium for storing a program. The computer-readable storage medium may be applied to a terminal device or a network device provided in embodiments of the present application, and the program causes a computer to perform a method performed by the terminal device or the network device in various embodiments of the present application.

The computer-readable storage medium may be any usable medium that a computer can read, or a data storage device such as a server or a data center that includes one or more available media integrations. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

An embodiment of the present application further provides a computer program product. The computer program product includes a program. The computer program product may be applied to a terminal device or a network device provided in embodiments of the present application, and the program causes a computer to perform a method performed by the terminal device or the network device in various embodiments of the present application.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to a terminal device or a network device provided in embodiments of the present application, and the computer program causes a computer to perform a method performed by the terminal or the network device in various embodiments of the present application.

The terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In embodiments of the present application, “indicate” mentioned herein may refer to a direct indication, or may refer to an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between the two, or may mean that there is an association relationship between the two, which may also be a relationship such as indicating and being indicated, or configuring and being configured.

In embodiments of the present application, “pre-defined” or “pre-configured” may be implemented by pre-storing corresponding codes, tables, or other forms that can be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of the present application, a sequence number of the foregoing processes does not mean a sequence of execution. The execution sequence of the processes should be determined based on functions and internal logic of the processes, and should not constitute any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method, comprising:
receiving, by a first terminal device, first information from a network device in a non-terrestrial network;
determining, by the first terminal device, a first sequence based on the first information; and
determining, by the first terminal device, an uplink transmission resource on a first resource block based on the first sequence; wherein
the first sequence is a sequence corresponding to the first terminal device in a first sequence set, the first sequence set comprises a plurality of mutually orthogonal sequences, the first terminal device is one of a plurality of terminal devices, and the plurality of terminal devices multiplex the first resource block with a plurality of slots based on the plurality of sequences.

2. The method according to claim 1, wherein the plurality of sequences are in a one-to-one correspondence with the plurality of terminal devices.

3. The method according to claim 1, wherein the first information is carried in at least one of radio resource control (RRC) dedicated signaling or downlink control information (DCI).

4. The method according to claim 1, wherein before the receiving, by the first terminal device, the first information from the network device, the method further comprises:
transmitting, by the first terminal device, second information to the network device, wherein the second information indicates whether the first terminal device has a capability of supporting resource multiplexing.

5. The method according to claim 1, wherein the plurality of terminal devices form a first terminal device group, the first terminal device group is determined based on third information, and the third information comprises one or more of the following information: a service type of a terminal device, channel quality of the terminal device, location information of the terminal device, or capability information of the terminal device.

6. The method according to claim 1, wherein a quantity of the plurality of terminal devices is related to a quantity of sub-carriers or sub-channels corresponding to the first resource block.

7. The method according to claim 6, wherein a product of the quantity of the plurality of terminal devices and a first parameter is the quantity of sub-carriers corresponding to the first resource block, and the first parameter is a positive integer.

8. The method according to claim 1, wherein the plurality of sequences are a plurality of row sequences of a first matrix, and a quantity of the plurality of terminal devices is determined based on an order of the first matrix.

9. The method according to claim 1, wherein the first sequence is further determined based on at least one of a communication environment or a channel status of the first terminal device.

10. The method according to claim 9, wherein the plurality of sequences correspond to one or more channel quality metrics in the channel status of the first terminal device, and the first sequence is determined based on the one or more channel quality metrics.

11. The method according to claim 10, wherein when the plurality of sequences correspond to a plurality of channel quality metrics, a channel quality metric corresponding to the first sequence is a maximum value in the plurality of channel quality metrics.

12. The method according to claim 1, wherein a quantity of the plurality of terminal devices is k, k is a natural number greater than 1, and the first sequence set comprises:
a 1^{st} sequence [1, 1, 1, 1, . . . , 1, 1]; and
an s^{th} sequence
$$\begin{matrix}[ 1 , exp ( j*2* π / k *(s-1) ) , 1 , exp ( j * 2 * \frac{π}{k} * ( s - 1 ) * 2 ) , … , \\ 1 , exp ( j * 2 * \frac{π}{2} * ( s - 1 ) * ( k - 1 ) ) ] ,\end{matrix}$$
wherein j represents an imaginary unit, and 1<s≤k.

13. The method according to claim 1, wherein the plurality of sequences are determined based on a plurality of different root sequences, and the plurality of different root sequences are generated based on a cyclic shift of a first root sequence.

14. The method according to claim 13, wherein a sequence X_{m,n} obtained after the first root sequence is cyclically shifted is:
$${X}_{m , n} = {X}_{m} [ ( n + {C}_{n} ) mod N ] ,$$
wherein N represents a length of the sequence, n represents a sequence number of the cyclic shift performed on the first root sequence, n=0, 1, . . . , └N/S_{CS}┘−1, S_{CS} represents a step of the cyclic shift, Cₙ represents a quantity of steps of a cyclic shift corresponding to n, Cₙ=n*S_{cs}, Xₘ represents the first root sequence, m represents an index of the first root sequence, and 0≤m<N.

15. The method according to claim 14, wherein an element Xₘ(i) in the first root sequence Xₘ is:
$${X}_{m} ( i ) = {e}^{- j \frac{π mi ( i + 1 )}{N}} ,$$
wherein N represents a length of the first root sequence, and i=0, 1, . . . , N−1.

16. The method according to claim 1, wherein the plurality of sequences are determined based on a same root sequence.

17. The method according to claim 1, wherein the method further comprises:
separately multiplying, by the first terminal device, a modulation symbol by a plurality of elements in the first sequence.

18. The method according to claim 1, wherein the plurality of sequences are a group of orthogonal cover code (OCC) sequences, and the first sequence is a first OCC sequence.

19. The method according to claim 18, wherein the group of OCC sequences are used for a plurality of symbols or a plurality of slots, and the group of OCC sequences are distinguished by using a pseudorandom sequence.

20. A method, comprising:
transmitting, by a network device in a non-terrestrial network, first information to a first terminal device, wherein the first information is used to determine a first sequence, and the first sequence is used by the first terminal device to determine an uplink transmission resource on a first resource block; wherein
the first sequence is a sequence corresponding to the first terminal device in a first sequence set, the first sequence set comprises a plurality of mutually orthogonal sequences, the first terminal device is one of a plurality of terminal devices, and the plurality of terminal devices multiplex the first resource block based on the plurality of sequences.
